(19) United States
(12) Patent Application Publication
(10) Pub. No.: US 2008/0137891 A1
(43) Pub. Date: Jun. 12, 2008

(54) Cic Hearing Aid

(76) Inventor: Cesar Guilherme Vohringer, Sao Joao do Estoril (PT)

Correspondence Address: YOUNG & THOMPSON, 209 Madison Street, Suite 500, ALEXANDRIA, VA, 22314, US

(21) Appl. No.: 11/920,249

(22) PCT Filed: May 5, 2006
(86) PCT No.: PCT/NL2006/050110

§ 371 Date: Nov. 13, 2007

(30) Foreign Application Priority Data
May 13, 2005 (NL) 1029049
Aug. 27, 2005 (NL) 1029823
Oct. 6, 2005 (NL) 1030125

(51) Int. Cl. H04R 25/00

(52) U.S. Cl. 381/328

(57) ABSTRACT

Hearing aid to be fitted deep in the auditory canal. Seen from the tympanum this comprises a fitting part which is adapted to the auditory canal concerned. Inside this is a sleeve, in which the electronics part is arranged with a speaker part facing the tympanum. On the other side is a microphone part. A battery connecting to an electronics part and accommodated in the sleeve is fitted. There are suitable contacts. The battery can be pushed through the open end of the sleeve, which is preferably flexible, towards the electronics part. As a result of this, a particularly compact construction can be provided which also serves as sound inlet. By lengthening the sleeve, interfering sound influences can be reduced further.

The present invention relates to a CIC hearing aid comprising an electronics part with a microphone on one side and a speaker on the opposite side as well as an amplifier, which electronics part is provided with battery connections, a battery accomodation and a fitted part adapted to the ear concerned.

A hearing aid of this type, which is completely invisible to wear, is disclosed in WO 99/13686 in the name of L. G. Borderwijk. In this publication a hearing aid to be placed deep inside the auditory canal is described, consisting of two parts which can be connected together, in which the electronics and the battery are accommodated. A construction of this type is preferably digitally implemented and an appreciable improvement in the sound quality compared with conventional aids can be achieved with this. In particular, because of the fitting deep inside the ear, a far more natural sound is perceived by the user. Because of the design of the aid and the omission of as many parts as possible in the concha of the ear, no occlusion effect occurs, that is to say the user hears his own voice undistorted. For a hearing aid of this type it is important that the fitted part is always individually adapted to each ear to avoid leakage of sound. In this proposal the battery is fitted on the speaker side. As a result of this, the aid can be constructed especially compact.

The aim of the present invention is to provide an improved hearing aid which can be made more simply and further reduced in size, is hardly visible and with which a further improvement in the functioning can be obtained.

This aim is realised with the hearing aid described above in that the battery accomodation is arranged on the microphone side and comprises a case, connected to the electronics part, of which the first end pointing away from the electronics part is open for taking said battery and for providing a sound inlet in the space between said case and the battery fitted therein.

In the state of the art it is known per se to fit the battery accomodation on the microphone side. A wide variety of constructions with hinged lids and the like have been proposed. The construction in this case was always such that the battery accomodation had an increasingly large cross-sectional size in the direction from the speaker to the microphone.

According to the invention it is now proposed to make the case as battery accomodation. For this purpose the case is preferably made as a flexible case at least near the final position, i.e. the position of use, of the battery. As a result of this, the battery, which is inserted from the open first end of the case, is accommodated in a clamped manner. With this arrangement the ease can move outwards elastically at the location of the battery. With such a simple construction the dimensions of the accomodation around the battery can be kept particularly swill. Indeed the wall thickness of the case can be comparatively small and is preferably between 0.1 and 1 mm. Consequently, in practice the cross-sectional size of the case will be smaller than the cross-section of the hearing aid with the fitted piece fitted thereon. It has been found that if this requirement is met, the sound quality is appreciably improved. Although not of importance for the scope of protection of subject patent, it is assumed that by this embodiment reflections of sound from the battery accomodation into the auditory canal are prevented. A battery tray with lid is no longer used. The first end is permanently open.

The case described above can either be permanently fixed to the electronics part or not. Moreover, it is possible to provide the second end of the case located opposite the first end with a closure. This creates an accomodation for taking the electronics. The fitted piece can optionally be fitted after the case and if the electronics are fully enclosed within the case, the fitted piece will be fitted over the case.

The sleeve is made in such a way that when the battery has been fitted space is left between the battery and the sleeve, preferably between the corners of the battery, to delimit a sound canal.

The advantage of fitting the battery on the microphone side, that is to say the outside of the ear, is that the battery contacts in question are easily accessible for connections to computers for adjusting the aid. Moreover, if, for example, a zinc-air battery is used, it will be guaranteed under all circumstances that the battery has sufficient oxygen to be able to function correctly. Removal of the battery is easy and can be done, for example, by a magnetic bar inserted from the first end.

Surprisingly it has been found that because of the particular shape of the sleeve less high demands have to be made on the fitted part. According to the invention the occlusion effect is effectively avoided. Consequently, it is possible in this construction to make the fitted part more or less as a standard part, i.e. the complicated procedure that is necessary in the state of the art to obtain a perfectly sound-tight fitted part is no longer necessary. Consequently, the costs of the hearing aid can be appreciably reduced.

The electronics comprise, apart from the amplifier, a microphone and a speaker. The microphone is adjacent to the battery, while the speaker is placed as close to the tympanum as possible. Power can be taken from the battery through contacts extending from the electronics into the sleeve.

According to a particular embodiment of the invention there is an extension of the sleeve that functions as a sound reception tube and preferably extends from the exit of the auditory canal and more in particular the end is approximately in line with the end of the antitrachus. This extension is preferably fitted closely around the sleeve or is integral therewith. Preferably this is made transparent. This extension is preferably made in such a way that the battery can be moved through it.

Surprisingly it has been found that if the tube is made transparent it is not or is hardly seen by other persons. The extension/sound reception tube can be used not only for receiving sound and accommodating the battery, but also for removing and then re-inserting the hearing aid into the auditory canal. That is to say, it is not necessary to affix separate means for removal, such as wires and the like. Moreover, such an extension provides a firm contact surface for the user. Such an extension has in such a sleeve a length such that it substantially surrounds the hearing aid, so when it is removed here is no risk of particular parts, such as the fitted part, remaining behind. Reinforcing means, such as a reinforcing rib, cord and the like, can be arranged in the sleeve or extension to ensure that when traction is applied for removing the aid the sleeve or extension does not fracture. It is possible to reduce the length of the extension by shortening it. In addition, it is possible not to shorten the reinforcing means, so that they protrude from the extension and can be used for removing the hearing aid.

The sound reception tube is preferably made with a bend to match the shape of the auditory canal and the concha and antitrachus adjoining this. The bent part, that is to say the part that extends furthest outwards relative to the tympanum, preferably has a length of several millimetres and more particularly about 6 mm. This possibly runs towards the outside in a funnel shape. By, according to the present invention, picking up the sound behind or next to the battery, a more compact construction can be provided. Because it has a short compact structure the hearing aid can be more easily inserted into the ear and removed therefrom.

Because of the length of the sound reception tube/extension the effect of sound leakages along the tube will be reduced even further. After all, the microphone is inside the sound reception tube. Consequently, the risk of feedback is reduced. According to the present invention an appreciable reception space is created in the form of the sound reception tube that is located in front of the microphone. The sound reception tube is preferably made of a transparent flexible plastic material.

The invention will be explained in more detail below with reference to illustrative embodiments shown in the drawing. In the drawing:

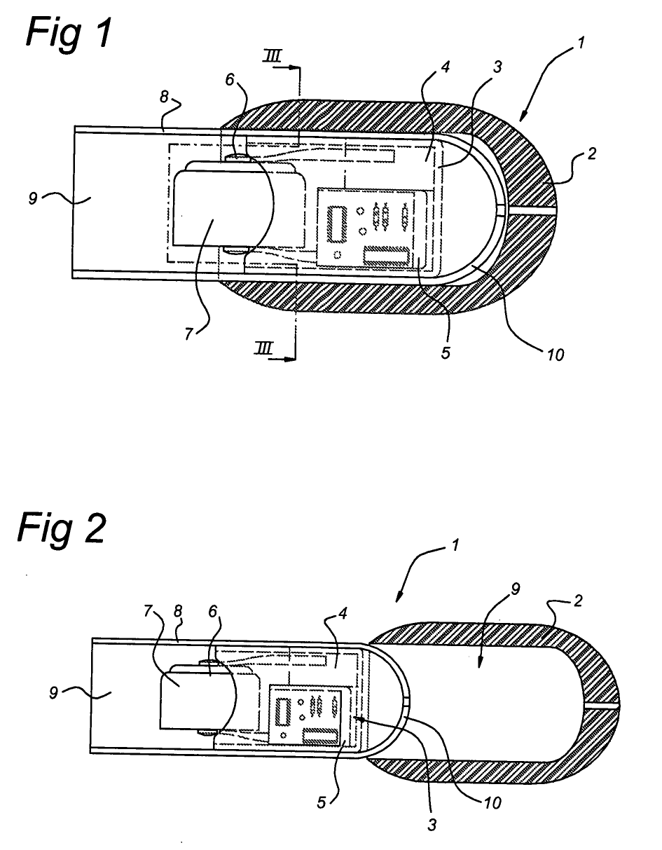

FIG. 1 shows dramatically a first embodiment of the hearing aid according to the invention;

FIG. 2 shows the hearing aid according to FIG. 1 with the various parts shown separately;

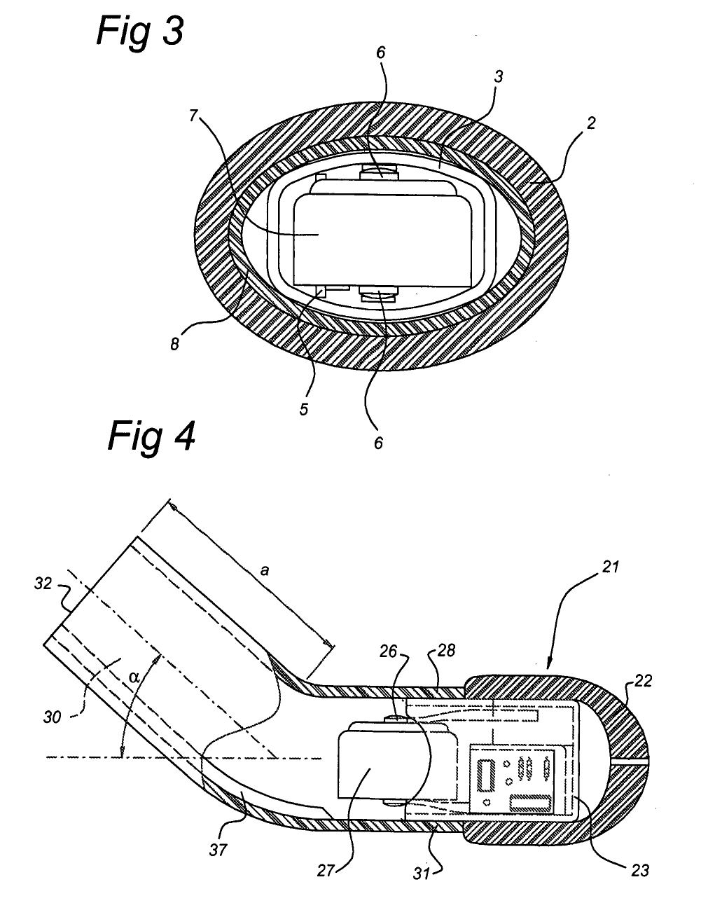

FIG. 3 shows the hearing aid according to FIG. 1 according to the section III-III;

FIG. 4 shows a second variant of the hearing aid according to the invention; and

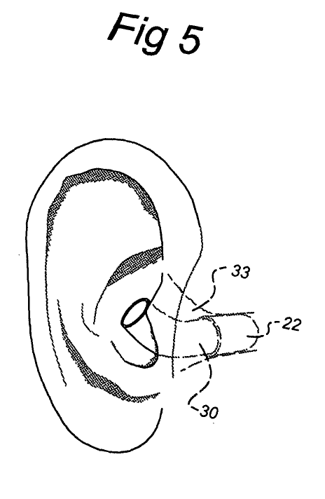

FIG. 5 shows the hearing aid according to FIG. 4 fitted in the auditory canal of a user.

FIG. 1 the hearing aid according to the invention is indicated by 1. This is provided with a fitting part 2. This part is designed to make the hearing aid suitable for auditory canals of various dimensions. Fitting part 2 can be a standard part.

The fitting part 2 is fitted around a sleeve 8 with a first open end 9 and a second closed end 10. Electronics part 3, with a speaker 4 and microphone 5, is located therein. From electronics part 3 battery contacts 6 extend into the sleeve for seating a battery 7 between them. As shown in FIG. 2, battery 7 has been pushed into the sleeve 8. This sleeve consists of a flexible plastic material which can be fitted tightly around the battery. There can be a camouflage cap behind/on the battery.

When placed in the ear, the fitted part 2 will be located comparatively close to the tympanum, while the battery in the sleeve 8 will be located closer to the exit of the auditory canal. From the figures it is clear that the largest cross-sectional size of the fitted part, for example at section III-III, is larger than the cross-sectional size of the sleeve 8. Consequently, this sleeve 8 will not or hardly be capable of reflecting sound, as a result of which the effect thereof on the audio qualities of the hearing aid is negligible. However, because the battery accomodation is arranged on the auricle side of the auditory canal it is easily accessible. Consequently, associated battery contacts can likewise be easily reached, so the hearing aid can easily be adjusted with known computers and the like. Between the battery 7 and the sleeve 8 (between the “corners” of the battery) there will always be some space to allow the sound through to the microphone (FIG. 3).

Moreover, when a battery 7 is used consuming oxygen an adequate supply of oxygen from the ambient air is always guaranteed.

In FIG. 4 a variant of the construction shown in FIGS. 1 to 3 is shown. In this figure the hearing aid 21 is indicated and provided with fitted part 22. In a corresponding manner there is an electronics part 23 provided with microphone and speaker, not shown in detail. The contacts for the battery are indicated by 26 and the battery itself by 27 and this is accommodated in a sleeve 28. This sleeve 28 is fixed to the electronics part 23 and, in contrast to the former embodiment, does not provide a second end made as a closure. The end closure of the electronics part is produced by the fitted part 22. There is an extension or sound reception tube 30. This extension is preferably an extension of the sleeve 8 and consists of the same material part. A reinforcement 37 has been made therein. From FIGS. 4 and 5 it can be seen that the sound reception tube is bent and the angle of bend is preferably about 70°. This divides the sound reception tube into an inlet part 32 and a receiving part 31. In addition, the electronics part preferably has a standard size. The fitted part 22 can be either specifically custom-made or chosen from a group of standard adaptable parts. In particular, because of the length of the sound reception tube, feedback occurs less readily and less high demands need to be made on the closure of the fitted part 22 relative to the auditory canal. The sound reception tube preferably consists of a standard part that is adapted to the dimensions of the battery or the battery accomodation.

In FIG. 5 the placing of the hearing aid 21 in the auditory canal 33 of a user can be seen. The length of the extension 30 is indicated by a, and amounts to about 6 mm. The various features are made in such a way that the first end 32 of the extension 30 is approximately in line with the free end of the antitrachus. In this embodiment the path for leaking sound which moves along the sleeve 30 and the fitted part 22 is appreciably enlarged compared with that shown in FIGS. 1 to 3, as a result of which feedback is further avoided or completely ruled out Consequently, it is possible to adjust the frequency range and the amplification factors positively, as a result of which the quality of the sound experienced increases further for the user. Moreover, in the embodiment according to FIGS. 4 and 5 it is possible to remove the hearing aid 21 easily. By grasping the inlet part 32 that is preferably made transparent, the entire hearing aid can be removed from the auditory canal. Ater this the battery can easily be moved towards the first end and replaced by another battery. Splitting of the hearing aid for cleaning can possibly be achieved by detaching fitted part 22 and sleeve 28.

After the above, variants will be immediately apparent to those competent in the state of the art which are generally known per se and the combination of which with what has been described above is obvious. Such variants are within the scope of the appended claims, wherein, moreover, in particular rights are requested for what has been described in the subsidiary claims without combination with the independent claim.

1. CIC hearing aid (1, 21), comprising an electronics part (3, 23) with a microphone (5) on one side and a speaker (4) on the opposite side as well as an amplifier, which electronics part (3, 23) is provided with battery connections (6, 26), a battery accomodation as well as a fitting part (2, 22) adapted to the ear concerned, characterised in that the battery accomodation (8, 28) is arranged on the microphone side and comprises a sleeve (8, 28), connected to the electronics part, of which the first end pointing away from the electronics part is open for taking said battery and for providing a sound inlet in the space between said sleeve and the battery fitted therein.

2. Hearing aid according to claim 1, wherein said sleeve comprises a flexible part of which the inside is designed for taking the battery with a tight fit.

3. Hearing aid according to claim 1, wherein said sleeve is provided with a closure at the end opposite the first end.

4. Hearing aid according to claim 1, wherein said sleeve (8, 22) has an extension (30).

5. Hearing aid according to claim 1, wherein the extension (30) consists of a transparent material.

6. Hearing aid according to claim 4, wherein said extension is bent.

7. Hearing aid according to claim 4, wherein the length of the free end of said extension as far as the bend amounts to at least 4 mm.

8. Hearing aid according to claim 6, wherein the angle of bend encompasses about 70°.

9. Hearing aid according to claim 1, wherein the free end of said extension is designed to extend to the immediate outside of the ear.

10. Hearing aid according to claim 4, wherein said extension comprises an elliptical cross-section.

11. Hearing aid according to claim 1, wherein the sleeve/extension is provided with a reinforcement.

12. Hearing aid according to claim 11, wherein said fitted part (22) is fitted around said sleeve.

13. Hearing aid according to claim 5, wherein said extension is bent.

14. Hearing aid according to claim 7, wherein the angle of bend encompasses about 70°.

15. Hearing aid according to claim 5, wherein the length of the free end of said extension as far as the bend amounts to at least 4 mm.

16. Hearing aid according to claim 6, wherein the length of the free end of said extension as far as the bend amounts to at least 4 mm.
